(19) United States
(12) Patent Application Publication
(10) Pub. No.: US 2025/0118459 A1
(43) Pub. Date: Apr. 10, 2025

(54) COMMUNICATION LINE

(71) Applicant: UNIQCONN INC., Seongnam-si (KR)

(72) Inventors: Young Dong KIM, Hwaseong-si (KR); Yong Hun OH, Pyeongtaek-si (KR); Joung Min PARK, Osan-si (KR); Jin Seok KIM, Seongnam-si (KR)

(73) Assignee: UNIQCONN INC., Seongnam-si (KR)

(21) Appl. No.: 18/888,469

(22) Filed: Sep. 18, 2024

(30) Foreign Application Priority Data
Oct. 6, 2023 (KR) 10-2023-0133443

(51) Int. Cl. H01B 11/18

(52) U.S. Cl. CPC H01B 11/1856; H01B 11/1886; H01B 11/1895

(57) ABSTRACT

The present invention relates to a communication line. The communication line according to an embodiment of the present invention includes at least one core portion including a dielectric core extending in a longitudinal direction and a rib member formed on an outer surface of the dielectric core, and a shielding portion including a shielding having a hollow tubular shape and a rail member formed to extend on an inner surface of the shielding and extending along the shielding in the longitudinal direction, wherein the at least one core portion is inserted into the shielding portion.

### CROSS-REFERENCE TO RELATED APPLICATION

This application claims priority to and the benefit of Korean Patent Application No. 10-2023-0133443, filed on Oct. 6, 2023, the disclosure of which is incorporated herein by reference in its entirety.

### BACKGROUND

### 1. Field of the Invention

The present invention relates to a communication line, and more particularly, to a communication line for signal transmission.

### 2. Discussion of Related Art

Communication lines made of dielectrics have a lower manufacturing cost than conductor-based communication lines and their installation and management are easier than optical-based communication lines, thereby efficiently utilizing the communication lines in chip-to-chip communications.

However, conventional communication lines have a problem in that an amount of the outside leakage of signals propagating in the conventional communication lines is excessive. Accordingly, the signals propagating through the conventional communication lines become incomplete, and as the length of the communication line increases, the attenuation of the signal may increase, cumulative signal loss may increase, and noise may be generated in electronic devices around the communication line.

Further, chip-to-chip communication may be performed in enclosed spaces such as server cases or computer cases, and in this case, excessive force is required to bend conventional communication lines. Accordingly, the conventional communication lines have the problem in that the conventional communication lines are difficult to be used in narrow or complex spaces because their shapes are not easily changed.

Meanwhile, the related art described above is technical information that the inventor possessed for deriving the present invention or acquired during the process of deriving the present invention, and cannot necessarily be considered as publicly known technology disclosed to the general public prior to the application of the present invention.

### RELATED ART DOCUMENT

### Patent Document

(Patent Document 1) Korean Laid-open Patent Publication No. 10-2010-0032769 (Mar. 26, 2010)

### SUMMARY OF THE INVENTION

The present invention is directed to providing a communication line of which manufacture and management are easy because the communication line can be manufactured separately.

The present invention is also directed to providing a communication line of which improvement and change are easy because the communication line can be coupled by changing the shape in various ways.

The present invention is also directed to providing a communication line that is easy to bend.

The present invention is also directed to providing a communication line capable of reducing signal loss.

The present invention is also directed to providing a communication line of which signal transmission is not weakened because an inclined surface of the communication line is coupled to have a high probability of having a contact portion even when bent.

The present invention is also directed to providing a communication line capable of transmitting various signals, in addition to data signals, with high quality without mutual interference.

Objects of the present invention are not limited to the above-described object and other objects that are not described may be clearly understood by those skilled in the art from the following descriptions.

According to an aspect of the present invention, there is provided a communication line which includes at least one core portion including a dielectric core extending in a longitudinal direction and a rib member formed on an outer surface of the dielectric core, and a shielding portion including a shielding having a hollow tubular shape and a rail member formed to extend on an inner surface of the shielding and extending along the shielding in the longitudinal direction, wherein the at least one core portion is inserted into the shielding portion.

The at least one core portion and the shielding portion may be formed separately.

The rail member may include a pair of a first rail and a second rail, the first rail and the second rail are formed to be spaced apart from each other, and the rib member may be inserted into a space between the first rail and the second rail.

The rib member may be present in the space between the first rail and the second rail to be spaced apart from at least one of the first rail and the second rail.

The communication line may further include a wire having a conductor through which a signal is transmitted and extending along the shielding in the longitudinal direction, wherein the wire may be disposed in the space between the first rail and the second rail.

A separation portion that separates the wire and the rib member may be formed in the rail member.

A separation prevention portion that fixes the rib member so that the rib member is not separated from the rail member may be formed at an end portion of the rail member.

The rib member may be formed to extend in the longitudinal direction on the outer surface of the dielectric core.

The rib member may include a first rib and a second rib, and the first rib and the second rib may be formed to be spaced apart from each other in the longitudinal direction on the outer surface of the dielectric core.

The at least one core portion may include a first core portion inserted into the shielding portion starting from one end of the first core portion and a second core portion inserted into the shielding portion following the other end of the first core portion.

The other end of the first core portion and one end of the second core portion in contact with the other end of the first core portion may be formed to have an incline.

The dielectric core may have a hollow tubular shape, and an electromagnetic wave signal received at one end of the dielectric core may be transmitted to the other end of the dielectric core in the longitudinal direction.

The rib member may be formed at equal intervals along a circumference of the dielectric core.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is an exploded perspective view of a communication line according to an embodiment of the present invention;

FIG. 2 is a cross-sectional view of a communication line in a direction perpendicular to a longitudinal direction according to an embodiment of the present invention;

FIG. 3 is an exploded perspective view of a communication line according to another embodiment of the present invention;

FIG. 4 is a cross-sectional view of the communication line in a longitudinal direction according to another embodiment of the present invention;

FIG. 5 is a perspective view of a core portion of the communication line according to another embodiment of the present invention;

FIG. 6 is a view for describing a communication system according to an embodiment of the present invention; and

FIG. 7 is a cross-sectional view of a communication line in a direction perpendicular to a longitudinal direction according to still another embodiment of the present invention.

### DETAILED DESCRIPTION OF EXEMPLARY EMBODIMENTS

Advantages and features of the present invention and methods of achieving the same will be clearly understood with reference to the accompanying drawings and embodiments described in detail below. However, the embodiments are provided in order to fully explain the present invention and fully explain the scope of the present invention for those skilled in the art. The scope of the present invention is only defined by the appended claims. Therefore, the present invention is not limited to the embodiments disclosed below, but may be implemented in various different forms without departing from the technical spirit of the present invention. That is, the scope of the present invention should be interpreted by the claims, and all technical ideas within the scope equivalent thereto should be construed as being included in the scope of the present invention.

The shapes, sizes, ratios, angles, numbers, or locations disclosed in the drawings for describing the embodiments of the present invention are exemplary, and therefore, the present invention is not limited to the matters illustrated. Further, even when only some components described in the claims are illustrated in the drawings, the components are selected as examples to clarify the description of the embodiments. That is, the drawings may be illustrated by selecting some configurations or operations that can most effectively convey the technical features or effects of the present invention.

Further, in description of a plurality of embodiments of the present invention in order, the configurations or operations of the present invention already described in the previously described embodiments are included again in the embodiments being described, and when the respective embodiments have substantially the same configuration or operation when compared organically, the descriptions of the configuration or operations may be omitted for a clear and concise description.

In description of the present invention, when it is determined that detailed descriptions of related well-known functions or configurations may unnecessarily obscure the gist of the present invention, detailed descriptions thereof will be omitted. Further, when the terms “include,” “have,” “consist of,” etc., are used in this specification, another portion may be added unless “only” is used. Further, when a component is expressed in the singular form, it includes a case where it includes a plural form unless the context clearly indicates otherwise. Further, in interpretation of components, it is interpreted as including a range of errors even when there is no separate explicit description.

It should be understood that, although the terms “first,” “second,” etc., may be used herein to describe various components, these components are not limited by these terms. The terms are only used to distinguish one component from another component. Therefore, it should be understood that a first component to be described below may be a second component within the technical scope of the present invention.

The individual features of the various embodiments of the present invention may be partially or wholly combined or combined with each other, and as can be fully understood by those skilled in the art, various technical connections and operations are possible, and each embodiment may be implemented independently of each other or may be implemented together in a related relationship.

In description of various embodiments of the present invention, when some configuration of an embodiment is substantially the same as or corresponding to some configuration of another embodiment described above, the description of that configuration may be omitted for a clear and concise description of the present invention. Further, when some configurations have a structure that is symmetrical with other configurations, for example, a structure with axial symmetry or rotational symmetry, so that both configurations are substantially the same configuration with only a difference in direction or location, the description of the configuration may be omitted for the sake of a clear and concise description of the present invention, unless it is necessary to specify the present invention.

Hereinafter, the present invention will be described in detail with reference to the accompanying drawings.

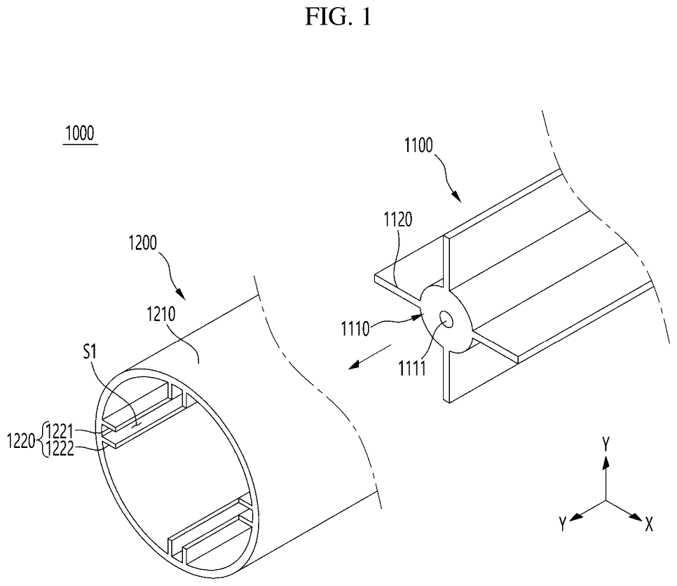

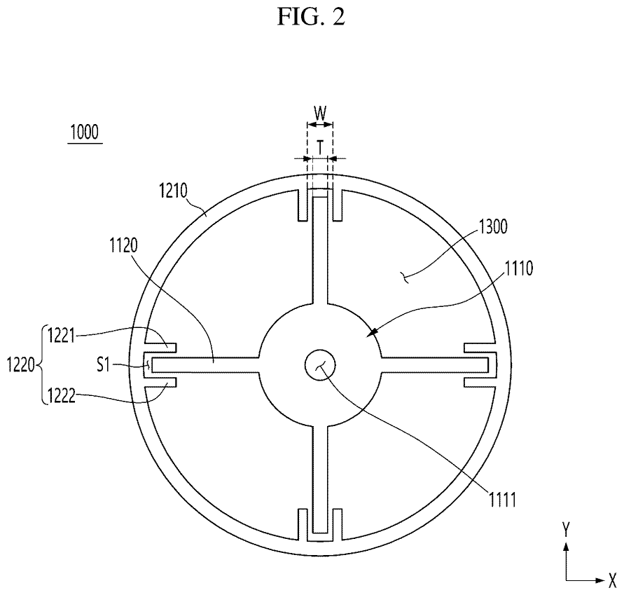

FIG. 1 is an exploded perspective view of a communication line according to an embodiment of the present invention. FIG. 2 is a cross-sectional view of a communication line in a direction perpendicular to a longitudinal direction according to an embodiment of the present invention.

First, referring to FIGS. 1 and 2, a communication line 1000 may include at least one core portion 1100 and a shielding portion 1200.

The at least one core portion 1100 may include a dielectric core 1110 and a rib member 1120.

The dielectric core 1110 may be formed to extend in a longitudinal direction. The longitudinal direction may be a Z-axis direction illustrated in FIG. 1.

The dielectric core 1110 may have a hollow tubular shape. For example, a central hole 1111 may be formed inside the dielectric core 1110. Further, an outer surface of the dielectric core 1110 and the central hole 1111 may have a circularly extended shape. In this case, as illustrated in FIGS. 1 and 2, the dielectric core 1110 and the central hole 1111 may share a central axis. However, the shapes and locations of the dielectric core 1110 and the central hole 1111 are not limited thereto. For example, a cross-section of the central hole 1111 in a direction perpendicular to the longitudinal direction may have a polygonal shape, and the central hole 1111 may be formed outside the central axis of the dielectric core 1110.

Meanwhile, permittivity is a value for the effect of a medium between charges on an electric field when the electric field acts between the charges, and depends on the frequency of an electromagnetic wave signal propagating in a dielectric. Further, when an electromagnetic wave signal propagates toward a boundary between materials having different permittivities, the electromagnetic wave signal may be adjusted to be totally reflected at the boundary between the two materials by adjusting permittivity, a signal incident angle of each of the two materials, or a frequency of the signal. Accordingly, by utilizing the above-described characteristics, the electromagnetic wave signal received at one end of the dielectric core 1110 in the communication line 1000 according to the embodiment of the present invention may be transmitted to the other end of the dielectric core 1110 in the longitudinal direction thereof.

Meanwhile, a material of the dielectric core 1110 may be a material having a higher permittivity than the air. The electromagnetic wave signal transmitted through the dielectric core 1110 may be totally reflected inside the dielectric core 1110 without externally leaking to an air layer 1300. That is, according to the embodiment of the present invention, the air layer 1300 may prevent the electromagnetic wave signal transmitted through the dielectric core 1110 from leaking out of the dielectric core 1110.

Here, the air layer 1300 may be filled with a dielectric material having a different permittivity from the permittivity of the material of the dielectric core 1110. For example, the air layer 1300 may be filled with a flexible dielectric material.

Meanwhile, in the communication line 1000 according to an embodiment of the present invention, the at least one core portion 1100 and the shielding portion 1200 may be made of the same dielectric material. In this case, since the permittivity is the same in all portion of the communication line 1000, the frequency of the signal may be easily adjusted so that the signal transmitted through the dielectric core 1110 does not leak to the air layer 1300.

In some cases, in the communication line 1000 according to an embodiment of the present invention, the at least one core portion 1100 and the shielding portion 1200 may be made of the same flexible dielectric material. In this case, since the force required for bending is the same in all portion of the communication line 1000, the shape of the communication line 1000 may be easily changed. Accordingly, even in a narrow space, the communication line 1000 may be installed in various shapes to connect a chip to a chip. Further, since the central hole 1111 is formed inside the dielectric core 1110, the communication line 1000 may be flexibly bent with a small force.

Meanwhile, the rib member 1120 according to the embodiment of the present invention may be provided as one or more rib members 1120. Further, the rib members 1120 may be formed on the outer surface of the dielectric core 1110. For example, the rib members 1120 may be formed to extend in the longitudinal direction on the outer surface of the dielectric core 1110. In an embodiment of the present invention, four rib members 1120 may be provided. Each of the four rib members 1120 according to an embodiment of the present invention may be formed in a radial direction from the dielectric core 1110. Here, the radial direction from the dielectric core 1110 may be a direction outward from the center of the dielectric core 1110.

The shielding portion 1200 may include a shielding 1210 and a rail member 1220.

The shielding 1210 may have a hollow tubular shape. Therefore, the at least one core portion 1100 may be inserted into the shielding portion 1200, that is, into the shielding 1210.

Meanwhile, the rail member 1220 may be provided as one or more rail members 1220. The rail members 1220 may be formed as a pair of a first rail 1221 and a second rail 1222. Therefore, the rail member may be formed as a pair of a first rail and a second rail.

The rail members 1220 may be formed to extend on an inner surface of the shielding 1210 and may extend along the shielding 1210 in the longitudinal direction. For example, each of the first rail 1221 and the second rail 1222 may be formed to extend on the inner surface of the shielding 1210 and may extend along the shielding 1210 in the longitudinal direction.

The rail members 1220 may be formed at equal intervals along a circumference of the dielectric core 1110.

The first rail 1221 and the second rail 1222 may be formed to be spaced apart from each other. A distance W between the first rail 1221 and the second rail 1222 may be predetermined as a certain length. In an embodiment of the present invention, the distance W may be greater than a thickness T of the rib member 1120. Therefore, the rib member 1120 may be inserted into a space S1 between the first rail 1221 and the second rail 1222. For example, as illustrated in FIGS. 1 and 2, when four rail members 1220 and four rib members 1120 are provided, each of the plurality of rib members may be inserted into a corresponding rail member.

Further, the rib member 1120 may be present in the space S1 between the first rail 1221 and the second rail 1222 to be spaced apart from at least one of the first rail 1221 and the second rail 1222. Therefore, since the communication line 1000 is not fixed between the core portion 1100 and the shielding portion 1200, the communication line 1000 may be easily bent.

Meanwhile, since the electric field propagates along dielectrics, when the dielectrics are connected to each other, the electric field may be leaked to the outside so that the loss rate may be increased. As described above, when the rib member 1120 is present to be spaced apart from at least one of the first rail 1221 and the second rail 1222, a contact surface is minimal so that the signal loss may be minimized. For example, when four rail members 1220 and four rib members 1120 are provided, one to three contact surfaces are formed due to the influence of gravity.

Meanwhile, in the communication line 1000 according to an embodiment of the present invention, the at least one core portion 1100 and the shielding portion 1200 may be formed separately. For example, as illustrated in FIG. 1, the core portion 1100 and the shielding portion 1200 may be provided separately and configured in a manner in which the core portion 1100 is inserted into the shielding portion 1200. Therefore, since the core portion 1100 and the shielding portion 1200 may be manufactured separately, the core portion 1100 and the shielding portion 1200 may be easily manufactured and managed. Since the core portion 1100 and the shielding portion 1200 may be coupled by changing the shape (size, structure, etc.) of at least one of the core portion 1100 and the shielding portion 1200 in various ways, the communication line 1000 may be easily improved, or may be changed according to the situation.

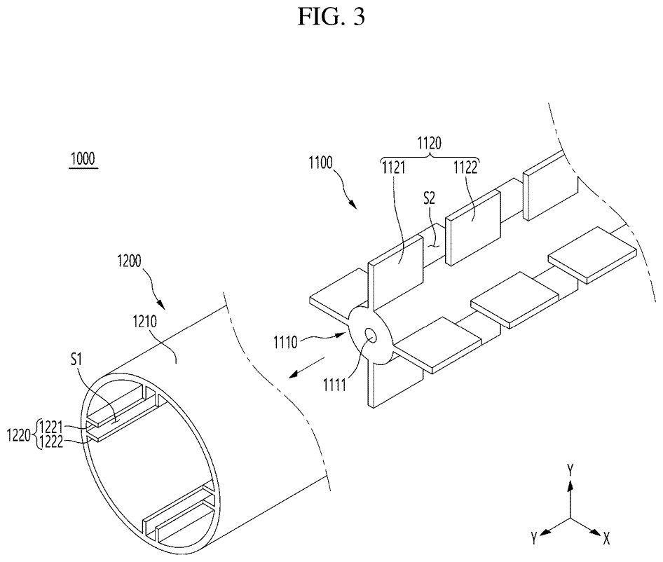

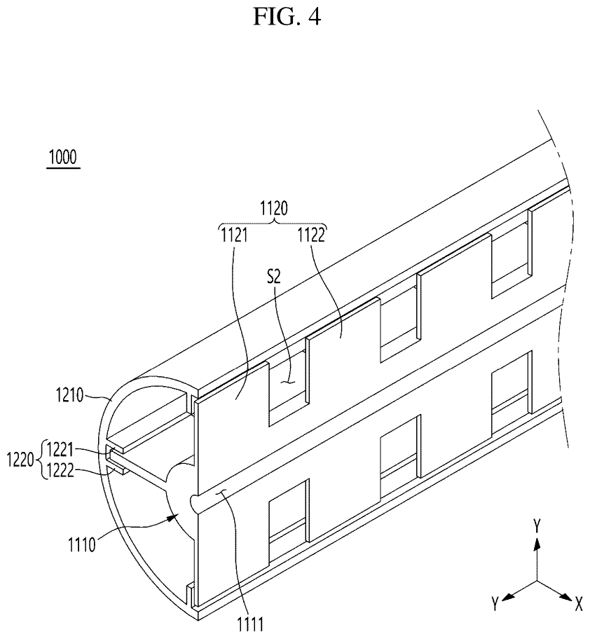

FIG. 3 is an exploded perspective view of a communication line according to another embodiment of the present invention. FIG. 4 is a cross-sectional view of the communication line in a longitudinal direction according to another embodiment of the present invention.

Referring to FIGS. 3 and 4, a rib member 1120 may include a first rib 1121 and a second rib 1122. The first rib 1121 and the second rib 1122 may be formed to be spaced apart from each other in a longitudinal direction on an outer surface of a dielectric core 1110. Therefore, a space S2 may be formed between the first rib 1121 and the second rib 1122. In this case, since the thicknesses and widths of the ribs of a communication line 1000 are smaller than those of a communication line formed with one rib, the transmission signal loss can be reduced and the communication line 1000 can be easily bent.

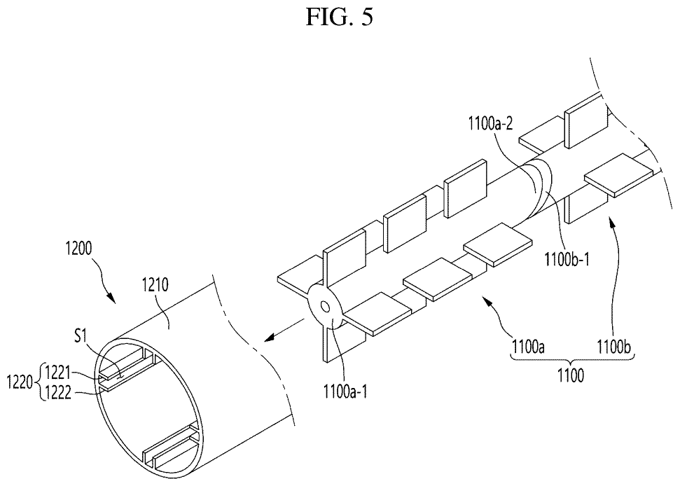

FIG. 5 is a perspective view of a core portion of the communication line according to another embodiment of the present invention.

Referring to FIG. 5, at least one core portion 1100 may include a first core portion 1100a inserted into a shielding portion 1200 starting from one end 1100a-1 of the first core portion 1100a and a second core portion 1100b inserted into the shielding portion 1200 following the other end 1100a-2 of the first core portion 1100a.

The other end 1100a-2 of the first core portion 1100a and one end 1100b-1 of the second core portion 1100b in contact with the other end 1100a-2 of the first core portion 1100a may be formed to have an incline. Therefore, even when the communication line 1000 is bent, the other end 1100a-2 of the first core portion 1100a and the one end 1100b-1 of the second core portion 1100b are in contact with each other, and thus the signal transmission may not be weakened.

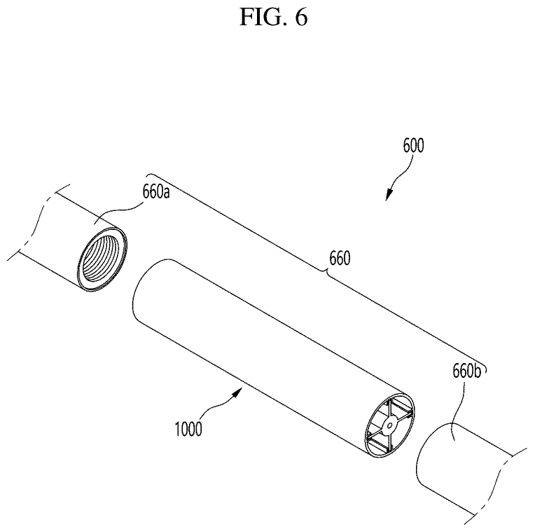

Meanwhile, a communication system using the communication line 1000 will be described with reference to FIG. 6.

FIG. 6 is a view for describing a communication system according to an embodiment of the present invention.

In FIG. 6, an antenna 660 and the communication line 1000 are illustrated as being disposed to be spaced apart from each other, but this is for ease of description, and in some cases, the antenna 660 may be in contact with the communication line 1000.

Referring to FIG. 6, a communication system 600 includes the communication line 1000 and the antenna 660 that outputs an electromagnetic wave signal. Here, the antenna 660 may be a transceiver that can not only output an electromagnetic wave signal but also receive an electromagnetic wave signal. In this case, one end of the communication line 1000 may face an antenna 660a that transmits a signal, and the other end of the communication line 1000 may face an antenna 660b that receives a signal. In this case, the communication line 1000 may transmit electromagnetic wave signals in both directions between the antennas 660a and 660b.

The antenna 660 may be a component that radiates and guides a communication signal. For example, a signal radiator that radiates a wireless signal may be disposed inside the antenna 660. Here, the signal radiator may have a patch shape or a horn shape. Alternatively, the antenna 660 may only guide a communication signal and may not have a signal radiator inside. For example, the antenna 660a may be connected to a signal generating portion disposed on a chip and may guide a signal output from the signal generating portion toward one end of the communication line 1000. In this case, the antenna 660a may serve as a waveguide that imparts directionality to a wireless signal or adjusts the direction of the signal.

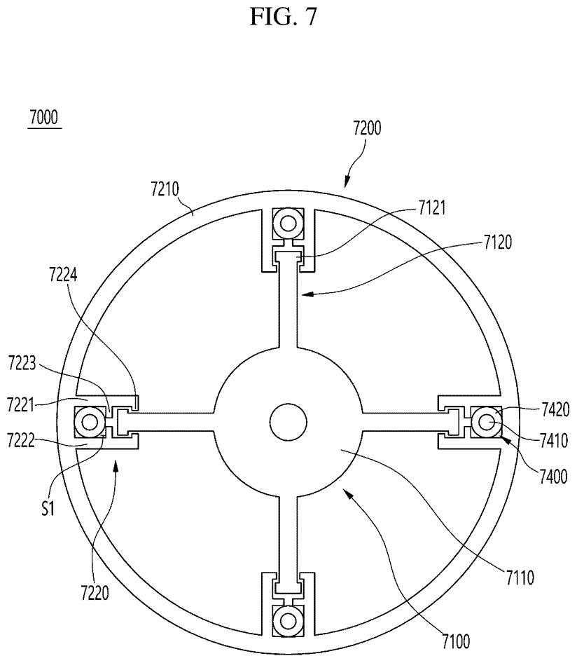

Meanwhile, according to still another embodiment of the present invention, a communication line may further include a wire having a conductor through which a signal is transmitted. This will be described with reference to FIG. 7.

FIG. 7 is a cross-sectional view of a communication line in a direction perpendicular to a longitudinal direction according to still another embodiment of the present invention.

Referring to FIG. 7, a communication line 7000 may further include a wire 7400 having a conductor 7410 through which a signal is transmitted and extending along a shielding 7210 in a longitudinal direction. The communication system may need to transmit various signals in addition to a signal transmitted through a dielectric core 7110. For example, in addition to a high-frequency data signal transmitted through the dielectric core 7110, supply of power or ground may be required, and transmission of low-speed or low-frequency signals, such as on-off signals, may be required. In this case, the wire 7400 may allow the above-described signals to be transmitted without degrading the transmission characteristics of the signals transmitted through the dielectric core 7110.

Meanwhile, in the embodiment of the present invention, the wire 7400 may include a covering 7420 that protects the conductor 7410. For example, referring to FIG. 7, the covering 7420 may have a shape that surrounds the conductor 7410. In this case, the signal transmitted through the conductor 7410 may not be emitted to the outside or influenced by the outside, and it is possible to prevent the quality of the signal transmitted through the wire 7400 from being degraded due to damage to the conductor 7410.

Referring to FIG. 7, the wire 7400 may be disposed in a space S1 between a first rail 7221 and a second rail 7222. For example, the wire 7400 may be inserted and disposed between the first rail 7221 and the second rail 7222. In this way, when the wire 7400 can be disposed between the shielding 7210 and a rib member 7120, a core portion 7100, a shielding portion 7200, and the wire 7400 may be manufactured separately, and then the core portion 7100 and the wire 7400 may be inserted into the shielding portion 7200, thereby assembling the communication line 7000. Accordingly, the process of manufacturing the respective components forming the communication line 7000 may be simplified, and the shape (size, structure, etc.) of at least one of the core portion 7100, the shielding portion 7200, and the wire 7400 may be easily changed.

Further, referring to FIG. 7, the wire 7400 may be disposed in a space between the shielding 7210 and an end portion of the rib member 7120. In this case, since the wire 7400 is disposed at a location far away from the dielectric core 7110, the transmission characteristics of the signal transmitted through the wire 7400 and the transmission characteristics of the signal transmitted through the dielectric core 7110 may not be affected by each other. Accordingly, the quality of the signal transmitted through the dielectric core 7110 may not be degraded.

Meanwhile, referring to FIG. 7, a separation portion 7223 that separates the wire 7400 and the rib member 7120 may be formed in the rail member 7220. For example, the separation portion 7223 may be formed inside the rail member 7220. Specifically, the separation portion 7223 may be formed between the first rail 7221 and the second rail 7222. More specifically, the separation portion 7223 may be formed as a portion that protrudes from the middle of the first rail 7221 toward the second rail 7222 and a portion that protrudes from the middle of the second rail 7222 toward the first rail 7221, as illustrated in FIG. 7. However, the shape of the separation portion 7223 is not limited to that illustrated in FIG. 7. For example, unlike that illustrated in FIG. 7, the separation portion 7223 may be formed as a curved line rather than a straight line. Further, unlike that illustrated in FIG. 7, the separation portion 7223 may be formed to connect the first rail 7221 and the second rail 7222.

When the separation portion 7223 is formed as described above, a space in which the wire 7400 can be disposed while the wire 7400 and the rib member 7120 are spaced apart from each other may be provided. In this case, when either the rib member 7120 or the wire 7400 is inserted, friction may not occur between the rib member 7120 and the wire 7400. Accordingly, the problem of the rib member 7120 and the wire 7400 being worn out may be prevented. Further, the core portion 7100 and the wire 7400 each through which the signal is transmitted may be spaced apart from each other so that the mutual interference phenomenon of each signal transmitted on the communication line 7000 may be reduced.

Meanwhile, referring to FIG. 7, a thickness-increasing portion 7121 whose thickness is increased compared to a body of the rib member 7120 may be formed at the end portion of the rib member 7120, and a separation prevention portion 7224 for fixing the thickness-increasing portion 7121 so that it does not fall off may be formed at an end portion of the rail member 7220. In this case, the rib member 7120 may not be separated from rail member 7220 due to the separation prevention portion 7224. Further, since the shaking of the dielectric core 7110 is reduced, the problem of the quality of the signal transmitted through the dielectric core 7110 being degraded when the communication line 7000 is subjected to impact or is physically deformed may be prevented. Further, since the core portion 7100 is fixed by the separation portion 7223 and the separation prevention portion 7224 and the wire 7400 is fixed by the inner surface of the shielding 7210 and the separation portion 7223, the structural stability of the communication line 7000 may be increased.

The operations of the method or algorithm described in association with the embodiments disclosed herein may be implemented directly in a hardware module, a software module, or a combination thereof executed by a processor. The software module may reside in a random access memory (RAM), a flash memory, a read-only memory (ROM), an erasable programmable read-only memory (EPROM), an electrically erasable programmable read-only memory (EEPROM), registers, a hard disk, a removable disk, a compact disc read-only memory (CD-ROM), or any other form of recording medium or storage medium known in the art. An exemplary recording medium or storage medium is coupled to a processor, such that the processor may read information from, and write information to, the recording medium or storage medium. Alternatively, the recording medium or storage medium may be integrated with the processor. The processor and the recording medium or storage medium may reside within an application-specific integrated circuit (ASIC). The ASIC may reside within a user terminal. Alternatively, the processor and the storage medium may reside as separate components within the user terminal.

According to one of the solutions of the present invention, the manufacture and management of a communication line can be easy because the communication line can be manufactured separately.

According to one of the solutions of the present invention, the improvement and change of a communication line can be easy because the communication line can be coupled by changing the shape in various ways.

According to one of the solutions of the present invention, a communication line can be easy to bend.

According to one of the solutions of the present invention, the communication line can reduce signal loss.

According to one of the solutions of the present invention, signal transmission cannot be weakened because an inclined surface of the communication line is coupled to have a high probability of having a contact portion even when bent.

According to one of the solutions of the present invention, the communication line can transmit various signals, in addition to data signals, with high quality without mutual interference.

The effects obtainable in the present invention are not limited to the above-described effects and other effects that do not described may be clearly understood by those skilled in the art from the above detailed descriptions.

What is claimed is:

1. A communication line comprising:
at least one core portion including a dielectric core extending in a longitudinal direction and a rib member formed on an outer surface of the dielectric core; and
a shielding portion including a shielding having a hollow tubular shape and a rail member formed to extend on an inner surface of the shielding and extending along the shielding in the longitudinal direction,
wherein the at least one core portion is inserted into the shielding portion.

2. The communication line of claim 1, wherein the at least one core portion and the shielding portion are formed separately.

3. The communication line of claim 1, wherein:
the rail member includes a pair of a first rail and a second rail;
the first rail and the second rail are formed to be spaced apart from each other; and
the rib member is inserted into a space between the first rail and the second rail.

4. The communication line of claim 3, wherein the rib member is present in the space between the first rail and the second rail to be spaced apart from at least one of the first rail and the second rail.

5. The communication line of claim 3, further comprising a wire having a conductor through which a signal is transmitted and extending along the shielding in the longitudinal direction,
wherein the wire is disposed in the space between the first rail and the second rail.

6. The communication line of claim 5, wherein a separation portion that separates the wire and the rib member is formed in the rail member.

7. The communication line of claim 1, wherein a separation prevention portion that fixes the rib member so that the rib member is not separated from the rail member is formed at an end portion of the rail member.

8. The communication line of claim 1, wherein the rib member is formed to extend in the longitudinal direction on the outer surface of the dielectric core.

9. The communication line of claim 1, wherein the rib member includes a first rib and a second rib, and
the first rib and the second rib are formed to be spaced apart from each other in the longitudinal direction on the outer surface of the dielectric core.

10. The communication line of claim 1, wherein the at least one core portion includes a first core portion inserted into the shielding portion starting from one end of the first core portion and a second core portion inserted into the shielding portion following the other end of the first core portion.

11. The communication line of claim 10, wherein the other end of the first core portion and one end of the second core portion in contact with the other end of the first core portion are formed to have an incline.

12. The communication line of claim 1, wherein the dielectric core has a hollow tubular shape, and
an electromagnetic wave signal received at one end of the dielectric core is transmitted to the other end of the dielectric core in the longitudinal direction.

13. The communication line of claim 1, wherein the rib members are formed at equal intervals along a circumference of the dielectric core.
